(19) United States
(12) Patent Application Publication
(10) Pub. No.: US 2025/0306258 A1
(43) Pub. Date: Oct. 2, 2025

(54) WIRE GRID POLARIZER AND METHOD OF MANUFACTURING THE SAME

(71) Applicant: Samsung Display Co., Ltd., Yongin-Si (KR)

(72) Inventors: Israel Esteban LAZO MARTINEZ, Yongin-si (KR); Suk Hoon KANG, Yongin-si (KR); Hyung Guen YOON, Yongin-si (KR)

(21) Appl. No.: 19/008,631

(22) Filed: Jan. 3, 2025

(30) Foreign Application Priority Data
Mar. 27, 2024 (KR) 10-2024-0041680

(51) Int. Cl. G02B 5/30

(52) U.S. Cl. CPC G02B 5/3058; G02B 5/3075

(57) ABSTRACT

A wire grid polarizer according to an embodiment includes a substrate and a metal nanopattern located on the substrate, the metal nanopattern includes a metal mixture, and wherein the metal mixture includes silver aggregates and silver nanoparticles.

### CROSS-REFERENCE TO RELATED APPLICATION

This application claims priority to and the benefit of Korean Patent Application No. 10-2024-0041680 filed at the Korean Intellectual Property Office on Mar. 27, 2024, the entire contents of which are incorporated herein by reference.

### BACKGROUND

### (a) Technical Field

The present disclosure relates to a wire grid polarizer and a method of manufacturing the wire grid polarizer.

### (b) Description of the Related Art

Unpolarized light is made up of electromagnetic waves having electric field vectors oriented orthogonally to each other in which the electric fields are perpendicular to the direction of travel of the electromagnetic waves. Liner polarizers are used to transmit light having an electric field oriented in a specific direction. A wire grid polarizer has metal wires arranged side by side at intervals narrower than the wavelength of the incident electromagnetic waves, and selectively transmit or reflect electromagnetic waves depending on their polarization.

Wire grid polarizers have advantages including their polarization effect, high reflectivity, and high conductivity, and can be used to improve light efficiency and viewing angle, so they are widely applied to display screens in mobile phones, and augmented reality (AR) and virtual reality (VR) headsets.

### SUMMARY

Embodiments may provide a wire grid polarizer with an improved polarization function and an economical and efficient method of manufacturing the wire grid polarizer.

The wire grid polarizer according to an embodiment includes a substrate and a metal nanopattern located on the substrate, the metal nanopattern includes a metal mixture, and the metal mixture includes silver aggregates and silver nanoparticles.

The silver aggregates may be in a form in which the silver nanoparticles are aggregated, and the diameter of the silver nanoparticles may be about 1 to about 100 nm.

The metal nanopattern may include a first region forming the surface of the metal nanopattern and a second region located inside the first region.

The amount of silver aggregates included in the first region may be larger than the amount of silver nanoparticles.

The amount of silver nanoparticles included in the second region may be larger than the amount of silver aggregates.

The second region may further include polymers and organic materials.

A method of manufacturing a wire grid polarizer according to an embodiment includes applying a transparent ink on a substrate, pressing the transparent ink with a transparent mold, exposing the transparent mold to ultraviolet rays, and removing the transparent mold to form a metal nanopattern, wherein the transparent ink includes a photosensitive composition and a solvent, the photosensitive composition includes a silver precursor and a radical photoinitiator, and in the step of exposing the transparent mold to ultraviolet rays, an in-situ reduction method is used in which the silver precursor is reduced to silver.

The silver precursor may comprise 1 to 10 wt % of the total weight of the transparent ink. The silver precursor may include at least one of AgNO₃ or AgO₂.

The radical photoinitiator may comprise 0.1 to 0.5 wt % of the total weight of the transparent ink.

The radical photoinitiator may include at least one of 2-hydroxy-methylpropiophenone or diphenyl(2,4,6-trimethylbenzoyl)phosphine oxide, which is a monomeric photoinitiator.

The solvent may include any one of a protic solvent, an aprotic solvent, and a mixture of the protic solvent and the aprotic solvent.

The protic solvent may include at least one of H₂O, CH₃CH₂OH, or CH₃CH(OH)CH₃. The aprotic solvent may include at least one of CH₃CN, CH₂Cl₂, or CH₃COCH₃.

The transparent ink further may further comprise a monomer, and the monomer may include at least one of acrylate or epoxy.

The transparent mold may include at least one of a polymer or an acrylate-based compound.

In the exposing the transparent mold to the ultraviolet rays, the irradiation time of the ultraviolet rays may be 10 to 180 s, and the intensity of the ultraviolet rays may be 0.2 W/cm².

The method may further comprise performing a plasma etching step after the removing the transparent mold.

A method of manufacturing a polarizer according to an embodiment includes filling the transparent mold with transparent ink, exposing the transparent mold filled with the transparent ink to ultraviolet rays, forming a metal nanopattern by pressing the mold on a substrate, and removing the transparent mold, wherein the transparent ink includes a photosensitive composition and a solvent, the photosensitive composition includes a silver precursor and a radical photoinitiator, and the exposing the transparent mold to ultraviolet rays performs an in-situ reduction method in which the silver precursor is reduced to silver.

The method may further comprise applying a second solvent on the substrate, and the second solvent may be a hydrophilic solution.

According to embodiments, the polarization effect, reflectance, and conductivity of a wire grid polarizer may be improved. Additionally, the wire grid polarizer can be manufactured more economically and efficiently.

### BRIEF DESCRIPTION OF THE DRAWINGS

FIG. 1 is a diagram showing a schematic structure of a wire grid polarizer according to an embodiment.

FIG. 2 provides images of light being transmitted or reflected by a wire grid polarizer, respectively.

FIG. 3 is a schematic diagram of a wire grid polarizer according to an embodiment.

FIG. 4 is a schematic cross-sectional view of a wire grid polarizer according to an embodiment.

FIG. 5 is a flowchart of a method of manufacturing a wire grid polarizer according to an embodiment.

FIG. 6 illustrates cross-sectional views of a wire grid polarizer at steps in a manufacturing process according to an embodiment.

FIG. 7 is a flowchart of a method of manufacturing a wire grid polarizer according to an embodiment.

FIG. 8 illustrates cross-sectional views of a wire grid polarizer at steps in a manufacturing process according to an embodiment.

FIG. 9 provides images from before and after exposing transparent ink to ultraviolet rays.

FIG. 10 is a graph showing the reflectance of a wire grid polarizer depending on a solvent used in a manufacturing process.

FIG. 11 provides images showing reflectance of a wire grid polarizer depending on the solvent used in a manufacturing process.

### DETAILED DESCRIPTION OF THE EMBODIMENTS

Hereinafter, with reference to the attached drawings, various embodiments of the present disclosure will be described in detail so that those skilled in the art can easily implement the present disclosure. The invention may be implemented in many different forms and is not limited to the embodiments described herein.

In order to clearly explain the present disclosure, parts that are not relevant to the description are omitted, and identical or similar components are assigned the same reference numerals throughout the specification.

In addition, the size and thickness of each component shown in the drawings are arbitrarily shown for convenience of explanation, so the present disclosure is not necessarily limited to that which is shown. In the drawing, the thickness is enlarged to clearly express various layers and regions.

And in the drawings, for convenience of explanation, the thicknesses of some layers and regions are exaggerated.

Additionally, when a part of a layer, membrane, region, or plate is said to be “above” or “on” another part, this includes not only cases where it is “directly above” another part, but also cases where there is another part in between. In contrast, when an element is referred to as being “directly on” another element, there are no intervening elements present. In addition, being “above” or “on” a reference portion means being located above or below the reference portion, and does not necessarily mean being located “above” or “on” it in the direction opposite to gravity.

In addition, throughout the specification, when a part is said to “include” a certain element, this means that it may further include other elements, rather than excluding other elements, unless specifically stated to the contrary.

In addition, throughout the specification, when reference is made to “on a plane,” this means when the target portion is viewed from above, and when reference is made to “in a cross-section,” this means when a cross-section of the target portion is cut vertically and viewed from the side.

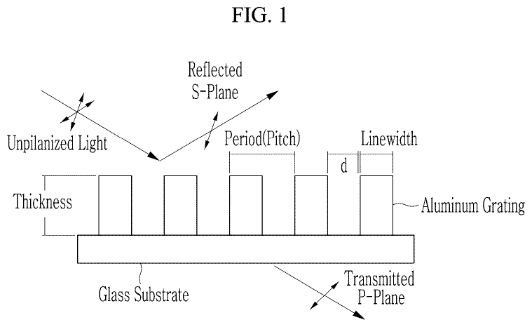

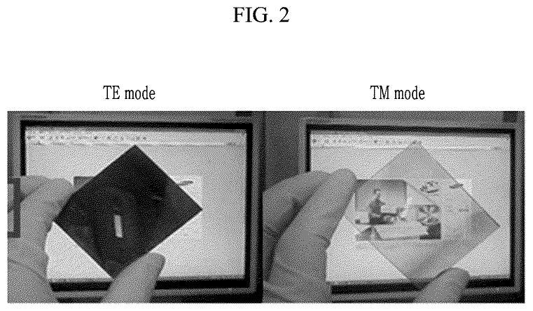

A structure of a wire grid polarizer and how it functions are described with reference to FIGS. 1 and 2. FIG. 1 is a cross-sectional view of the schematic structure of the wire grid polarizer according to an embodiment.

FIG. 2 provides images showing the transmission mode and reflection mode of the polarizer, respectively.

As shown in FIG. 1, when the spacing d between metal nanopatterns is smaller than the half-wavelength of the incident electromagnetic wave, strong polarization occurs, and when the spacing d between nanopatterns is larger than the wavelength of the incident electromagnetic wave, the transmittance is high. The period, which is the interval from one starting point of one nanopattern to the starting point of the next nanopattern, may be approximately 200 nm, and the thickness of the metal nanopattern may be approximately 100 nm.

As shown in FIGS. 1 and 2, electromagnetic waves TM having an electric filed vector incident in a direction perpendicular to the metal nanopattern of the polarizer transmit through the polarizer, and electromagnetic waves TE having an electric filed vector incident in a direction parallel to the metal nanopattern are reflected or absorbed. As shown in the left image of FIG. 2, electromagnetic waves in the visible light region cannot be observed because they are reflected or absorbed by the polarizer when the direction of the electric field vector is parallel to the metal nanopattern. The wire grid polarizer may increase efficiency by reflecting light parallel to the metal nanopattern as much as possible and then recycling it. In addition, by increasing the conductivity and increasing the number of free electrons, the wire grid polarizer may increase the polarization ratio by maximizing the attenuation rate of electromagnetic waves in the direction parallel to the pattern.

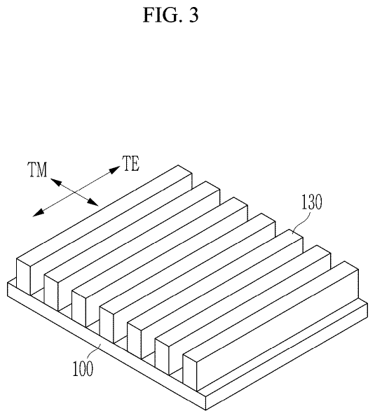

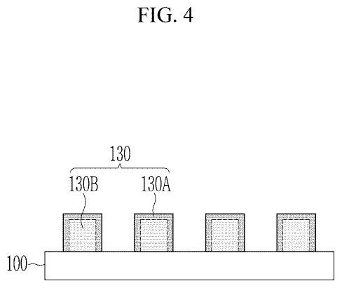

Hereinafter, a polarizer according to an embodiment will be illustrated in more detail with reference to FIGS. 3 and 4. FIG. 3 is a diagram of the wire grid polarizer according to an embodiment, and FIG. 4 is a cross-sectional view of the wire grid polarizer according to an embodiment.

A wire grid polarizer according to an embodiment includes a substrate 100. The substrate 100 may include a flexible material such as plastic that can be easily bent, bent, folded, or rolled, or may include a rigid substrate.

A metal nanopattern 130 is located on the substrate 100. The metal nanopattern 130 may in have a rod shape extending in one direction.

As shown in FIG. 4, each metal nanopattern among a plurality of metal nanopatterns 130 may include a first region 130A and a second region 130B. The first region 130A is exposed to air, and the second region 130B is located inside the first region 130A.

The first region 130A may surround the second region 130B. In an embodiment, the wire grid polarizer may include a transparent layer in contact with the first regions 130A of the plurality of metal nanopatterns 130 so that the first regions 130A are not exposed to air.

Each of the first region 130A and the second region 130B is made of a metal compound.

Metal compounds include silver (Ag) aggregates and silver nanoparticles (Ag nanoparticles) and may additionally include polymers and organic substances.

Silver (Ag) atoms gather to form silver nanoparticles (Ag nanoparticles), and silver nanoparticles (Ag nanoparticles) gather together to form silver (Ag) aggregates. The diameter of silver nanoparticles (Ag nanoparticles) may be about 1 to 100 nm, and they clump together to form silver aggregates.

The first region 130A and the second region 130B have different concentrations of silver (Ag) aggregates. The amount of silver aggregates included in the first region 130A may be larger than the amount of silver nanoparticles (Ag nanoparticles).

The concentration of the silver (Ag) aggregate may have a concentration gradient that decreases from the first region 130A to the center of the second region 130B. The amount of silver nanoparticles (Ag nanoparticles) included in the second region may be larger than the amount of silver aggregates.

In the first region 130A, most of the reduction and aggregation of silver nanoparticles (Ag nanoparticles) occur. This is because after the silver (Ag) precursor is reduced on the surface of a metal nanopattern 130, the reflectance of the surface of the metal nanopattern 130 becomes very high and it no longer absorbs but reflects ultraviolet rays. Accordingly, the first region 130A has the highest ratio of silver aggregates in the entire composition of the metal nanopattern 130 and is mostly composed of silver aggregates. The second region 130B has a higher proportion of dispersed silver nanoparticles (Ag nanoparticles) than the proportion of silver aggregates, and may include polymers and organic substances.

The wire grid polarizer, which may be referred to as a polarizing plate, according to an embodiment has an excellent polarization effect and has the advantage of being able to reuse light and re-polarize it because the reflectance is increased by using silver (Ag). In addition, the use of silver (Ag) has the advantage of increasing conductivity and thus increasing the polarization ratio, making it possible to provide a polarizing plate with further improved efficiency.

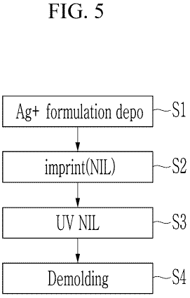

Hereinafter, a method of manufacturing a polarizing plate according to an embodiment will be described with reference to FIGS. 4 to 6. FIG. 5 is a flowchart of the method of manufacturing the wire grid polarizer according to an embodiment.

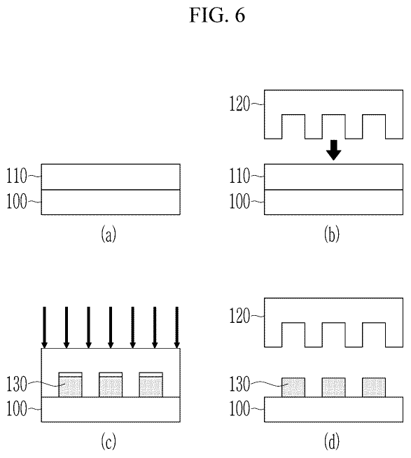

FIG. 6 illustrates cross-sectional views of the wire grid polarizer at steps in the manufacturing process according to an embodiment.

As shown in FIG. 6(a), transparent ink 110 is applied on the substrate 100 (step S1 in FIG. 5). The application method may be a coating method or a printing method.

The transparent ink 110 includes a photosensitive composition and a solvent. The photosensitive composition includes a silver precursor and a radical photoinitiator. The silver (Ag) precursor contains silver (Ag), a material that forms the metal nanopattern 130, in the form of silver ions (Ag), and the radical photoinitiator reacts with silver ions (Ag) when exposed to ultraviolet rays to form silver (Ag). It plays a role in initiating a chemical reaction that can be reduced. Silver (Ag) precursors may include AgNO₃ and AgO₂, for this embodiment. The radical photoinitiator may include at least one of 2-hydroxy-methylpropiophenone or diphenyl(2,4,6-trimethylbenzoyl)phosphine oxide, which is a monomeric photoinitiator.

Additionally, the solvent in the transparent ink 110 may be either protic, aprotic, or a mixture thereof. Embodiments of protic solvents may include H₂O, CH₃CH₂OH, and CH₃CH(OH)CH₃. Embodiments of aprotic solvents may include CH₃CN, CH₂Cl₂, and CH₃COCH₃.

Depending on the embodiment, the transparent ink 110 may further include a unit. Monomers may include acrylates and epoxies. The monomer serves to help the metal nanopattern adhere well to the substrate.

Next, as shown in FIG. 6(b), a transparent mold 120 is pressed on the substrate 100 on which the transparent ink 110 is applied (step S2 in FIG. 5). At this time, the transparent ink 110 composition enters the transparent mold 120 by capillary action.

Next, the transparent mold is exposed to ultraviolet rays as shown in FIG. 6(c) (step S3 in FIG. 5). At this time, silver ions (Ag) contained in the transparent ink 110 are reduced by ultraviolet rays through an in-situ reduction method. Reduction of silver (Ag) precursors mostly occurs in the region where ultraviolet rays reach first. As the silver (Ag) precursor is reduced, the proportion of silver (Ag) aggregates increases, increasing the reflectance. As the ultraviolet rays approach closer to the center of the metal nanopattern 130, they are reflected and do not reach the center.

This produces a concentration gradient in which the concentration of silver (Ag) aggregates decreases as it approaches the center of the metal nanopattern 130. When the reduction reaction and drying of the remaining transparent ink 110 are completed, the region with a high ratio of silver (Ag) aggregates in contact with the air, silver nanoparticles (Ag nanoparticles) that were reduced but not aggregated, and organic substances and polymers in the solution the metal nanopattern 130 is formed before being attached to the substrate consisting of a center with a high ratio of nanomaterials. The metal nanopattern 130 may be formed to include a first region 130A and a second region 130B, as shown in FIG. 4.

Next, the transparent mold 120 is removed as shown in FIG. 6(d) (step S4 in FIG. 5). Depending on the embodiment, after removing the transparent mold 120, a plasma etching step may be additionally included to remove remaining materials other than the metal nanopattern 130. Afterwards, the metal nanopattern 130 is formed on the substrate, and the wire grid polarizer having the structure shown in FIGS. 3 and 4 can be manufactured.

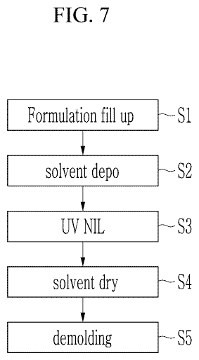

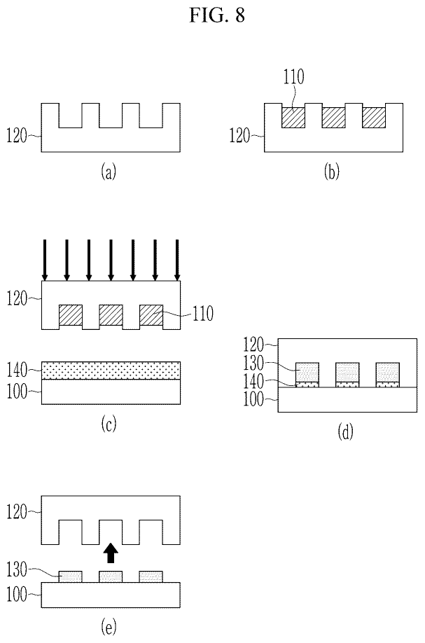

Hereinafter, the method of manufacturing a polarizing plate according to an embodiment will be described with reference to FIGS. 4, 7, and 8. FIG. 7 is a flowchart of the method of manufacturing of a wire grid polarizer according to an embodiment. FIG. 8 illustrates cross-sectional views of a wire grid polarizer at steps in a manufacturing process according to an embodiment.

FIG. 8(a) is a diagram showing the transparent mold 120. As shown in FIG. 8(b), the transparent mold 120 is filled with the transparent ink 110 (step S1 in FIG. 7).

Next, as shown in FIG. 8(c), a second solvent 140 is applied on the substrate 100 (step S2 in FIG. 7). Next, the transparent mold 120 is exposed to ultraviolet rays to reduce the transparent ink 110 within the mold (step S3 in FIG. 7). Reduction of silver (Ag) precursors mostly occurs in the region where ultraviolet rays reach first. As the silver (Ag) precursor is reduced, the proportion of silver (Ag) aggregates increases, increasing the reflectance. As the ultraviolet rays get closer to the center of the metal nanopattern 130, they are reflected and do not reach the center. Therefore, a concentration gradient exists in which the concentration of silver (Ag) aggregates decreases as it approaches the center of the metal nanopattern 130. When the reduction reaction and drying of the remaining transparent ink 110 are completed, the region with a high ratio of silver (Ag) aggregates in contact with the air layer, silver nanoparticles (Ag nanoparticles) that were reduced but not aggregated, and organic substances and polymers in the solution the metal nanopattern 130 is formed before being attached to the substrate consisting of a center with a high ratio of nanomaterials.

Next, as shown in FIG. 8(d), the metal nanopattern 130 before being attached to the transparent mold 120 and the substrate 100 is pressed onto the substrate. At this time, the second solvent 140 promotes capillary action during the drying process (step S4 in FIG. 7) to ensure that the metal nanopattern 130 is well attached to the substrate. The second solvent 140 must not damage the metal nanopattern 130 and may be hydrophilic to prevent dehydration on the substrate.

Next, the mold is removed as shown in FIG. 8(e) (step S5 in FIG. 7). The metal nanopattern 130 is formed on the substrate, and the wire grid polarizer with the structure shown in FIG. 3 can be manufactured.

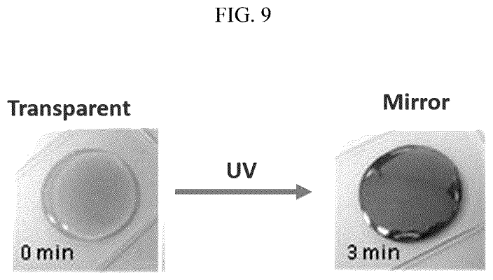

Hereinafter, a polarizing plate manufactured according to an embodiment will be described in more detail with reference to FIGS. 9 to 11.

FIG. 9 provides images from before and after exposing the transparent ink 110 containing a silver (Ag) precursor to ultraviolet rays. That is, referring to FIG. 9, it can be seen that when the transparent ink 110 is exposed to ultraviolet rays for 3 minutes, the silver (Ag) precursor in the transparent ink is reduced to form a reflective surface.

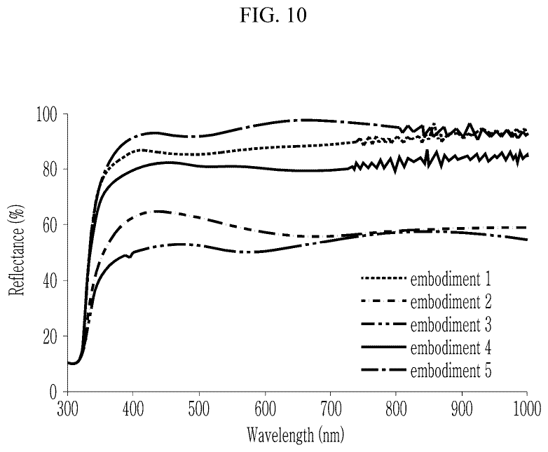

FIG. 10 is a graph showing the reflectance of the metal nanopattern 130 according to the type of solvent in the transparent ink 110. Embodiments 1 to 5 all contained 0.5 wt % of 2-hydroxy-2-methylpropiophenone as a photoinitiator based on the total weight, and 5 wt % of AgNO₃ as a silver (Ag) precursor based on the total weight. Embodiment 1 uses 100% H₂O as a solvent and shows the reflectance when exposed to ultraviolet light for 40 seconds. Embodiment 2 uses 100% C₂H₅OH as a solvent and shows the reflectance when exposed to ultraviolet rays for 24 seconds. Embodiment 3 shows the reflectance when a mixture of 80% H₂O and 20% C₂H₅OH was used as a solvent and exposed to ultraviolet rays for 27 seconds. Embodiment 4 shows the reflectance when 100% CH₃CN was used as a solvent and exposed to ultraviolet light for 36 seconds. Embodiment 5 shows the reflectance when a mixture of 80% H₂O and 20% CH₃CN was used as a solvent and exposed to ultraviolet light for 32 seconds.

Looking at FIG. 10, it can be seen that the reflectance increases rapidly for electromagnetic waves after 300 nm. In particular, it was confirmed that embodiments 1, 4, and 5 had reflectance of about 70 to 90 percent in a wavelength range of 400 nm or more and relatively high reflectance in the visible light region.

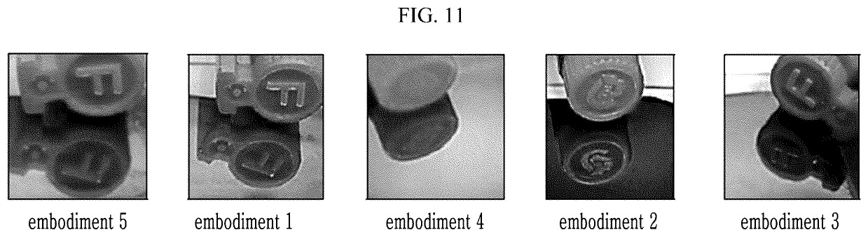

FIG. 11 provides images showing reflectance of the metal nanopattern 130 according to the type of solvent. It was confirmed that Embodiment 5 had the most transparent surface.

According to the method of manufacturing a polarizing plate according to an embodiment, the process is minimized by not going through the step of depositing a metal on the substrate and not going through the etching step that is generally essential, the risk of elaborate etching can be reduced, making it possible to manufacture polarizers economically and efficiently.

While the present disclosure has been described with reference to embodiments thereof, it will be apparent to those of ordinary skill in the art that various changes and modifications may be made thereto without departing from the scope and spirit of the present disclosure as set forth in the following claims.

What is claimed is:

1. A wire grid polarizer, comprising:
a substrate; and
a metal nanopattern located on the substrate,
wherein the metal nanopattern includes a metal mixture, and
the metal mixture includes silver aggregates and silver nanoparticles.

2. The wire grid polarizer of claim 1, wherein
the silver aggregates are in a form in which the silver nanoparticles are aggregated, and
a diameter of the silver nanoparticles is about 1 to about 100 nm.

3. The wire grid polarizer of claim 1, wherein
the metal nanopattern comprises:
a first region forming a surface of the metal nanopattern; and
a second region located inside the first region.

4. The wire grid polarizer of claim 3, wherein
an amount of the silver aggregates contained in the first region is
larger than the amount of silver nanoparticles.

5. The wire grid polarizer of claim 3, wherein
an amount of silver nanoparticles contained in the second region is
larger than the amount of silver aggregates.

6. The wire grid polarizer of claim 5, wherein
the second region is a wire grid polarizer further comprising polymers and organic materials.

7. A method of manufacturing a wire grid polarizer, comprising:
applying a transparent ink on a substrate;
pressing the transparent ink with a transparent mold;
exposing the transparent mold to ultraviolet rays; and
removing the transparent mold to form a metal nanopattern,
wherein the transparent ink includes a photosensitive composition and a solvent,
the photosensitive composition includes a silver precursor and a radical photoinitiator, and
in the exposing the transparent mold to ultraviolet rays, an in-situ reduction method is used in which the silver precursor is reduced to silver.

8. The method of manufacturing the wire grid polarizer of claim 7, wherein
the silver precursor comprises 1 to 10 wt % of a total weight of the transparent ink.

9. The method of manufacturing the wire grid polarizer of claim 7, wherein
the silver precursor includes at least one of AgNO₃ or AgO₂.

10. The method of manufacturing the wire grid polarizer of claim 7, wherein
the radical photoinitiator comprises 0.1 to 0.5 wt % of a total weight of the transparent ink.

11. The method of manufacturing the wire grid polarizer of claim 7, wherein
the radical photoinitiator comprises at least one of 2-hydroxy-methylpropiophenone or diphenyl(2,4,6-trimethylbenzoyl)phosphine oxide, which is a monomeric photoinitiator.

12. The method of manufacturing the wire grid polarizer of claim 7, wherein
the solvent comprises any one of a protic solvent, an aprotic solvent, or a mixture of the protic solvent and the aprotic solvent.

13. The method of manufacturing the wire grid polarizer of claim 12, wherein
the protic solvent includes at least one of H₂O, CH₃CH₂OH, or CH₃CH(OH)CH₃.

14. The method of manufacturing the wire grid polarizer of claim 12, wherein
the aprotic solvent includes at least one of CH₃CN, CH₂Cl₂, or CH₃COCH₃.

15. The method of manufacturing the wire grid polarizer of claim 7, wherein
the transparent ink further comprises a monomer, and
the monomer includes at least one of an acrylate or an epoxy.

16. The method of manufacturing the wire grid polarizer of claim 7, wherein
the transparent mold includes at least one of a polymer or an acrylate-based compound.

17. The method of manufacturing the wire grid polarizer of claim 7, wherein
in the exposing the transparent mold to ultraviolet rays, an irradiation time of the ultraviolet rays is 10 to 180 s, and
an intensity of the ultraviolet rays is 0.2 W/cm².

18. The method of manufacturing the wire grid polarizer of claim 7, further comprising
performing a plasma etching step after the removing the transparent mold.

19. A method of manufacturing a wire grid polarizer, comprising:
filling a transparent ink into a transparent mold;
exposing the transparent mold filled with the transparent ink to ultraviolet rays;
forming a metal nanopattern by pressing the transparent mold on a substrate; and
removing the transparent mold,
wherein the transparent ink includes a photosensitive composition and a solvent,
the photosensitive composition includes a silver precursor and a radical photoinitiator, and
the exposing the transparent mold to the ultraviolet rays performs an in-situ reduction method in which the silver precursor is reduced to silver.

20. The method of manufacturing the wire grid polarizer of claim 19, further comprising
applying a second solvent on the substrate,
wherein the second solvent is hydrophilic.
